(19) United States
(12) Patent Application Publication
(10) Pub. No.: US 2025/0073776 A1
(43) Pub. Date: Mar. 6, 2025

(54) Method of Producing Spherical Copper Powder and a Product Thereof

(71) Applicant: Tata Steel Limited, Jamshedpur (IN)

(72) Inventors: Sista Kameswara Srikar, Jamshedpur (IN); Gourav Ranjan Sinha, Jamshedpur (IN); Srinivas Dwarapudi, Jamshedpur (IN); Abhijeet Premkumar Moon, Jamshedpur (IN); Deepak Kumar, Jamshedpur (IN)

(21) Appl. No.: 18/724,579

(22) PCT Filed: Dec. 27, 2022
(86) PCT No.: PCT/IB2022/062806

§ 371 Date: Jun. 26, 2024

(30) Foreign Application Priority Data
Dec. 27, 2021 (IN) 202131060931

(51) Int. Cl. B22F 1/065; B22F 9/20

(52) U.S. Cl. CPC B22F 1/065; B22F 9/20; B22F 2301/10; B22F 2304/10

(57) ABSTRACT

The present disclosure provides a method for synthesizing spherical copper powder and the copper powder obtained therefrom. The method includes mixing a copper oxide powder with a carbon source to obtain a mixture; heating the mixture at a temperature of 600-1070° C. for a period of more than 20 minutes in an inert atmosphere to obtain spherical copper powder; and separating the spherical copper powder from carbon to obtain pure spherical copper powder. The present method is a single step process where a precursor copper oxide powder is reduced and spherodized simultaneously to provide spherical copper powder. Spherical copper powders provided by the present methods are dense and spherical and have a mean particle size of less than 250 microns, purity of at least 98.5% by weight of copper, and an oxygen content of less than 0.25% by weight.

### CROSS-REFERENCE TO RELATED APPLICATIONS

This application is the United States national phase of International Patent Application No. PCT/IB2022/062806 filed Dec. 27, 2022, and claims priority to Indian Patent Application number 202131060931 filed Dec. 27, 2021, the disclosures of which are hereby incorporated by reference in their entireties.

### BACKGROUND OF THE INVENTION

### Field of the Invention

The present disclosure relates to the field of metallurgy, more particularly to a method for producing copper powder. The present disclosure provides a simple and economical method of producing dense, spherical copper powders directly from irregular copper oxide.

### Description of Related Art

Spherical copper powder is one of the most desired metal powders for various applications such as friction components, break liners, conductive coating, thermal sprays, metal injection molding and additive manufacturing. Most of the copper powder manufacturing techniques such as electrolysis, water atomization and thermal reduction provide irregular and flaky powders. Synthesis of spherical copper powder is quite challenging and very few processes such as gas atomization, centrifugal atomization, plasma spherodization are used for synthesis of spherical copper. While the atomization techniques attract huge operation costs, spherodization techniques require pure irregular copper powders as precursors adding the processing time and cost.

In addition to known methods of synthesizing copper powders, many studies have explored new ways of synthesizing spherical copper powder. CN101590530B is directed to a synthesis of spherical copper powders with a high oxidation resistance. The method comprises reducing copper-containing starting materials such as hydrated copper sulphate or copper nitrate in the presence of a solvent such as copper chloride hydrate along with auxiliary agents such as inorganic salts and water-soluble polymers at 40 to 100° C. for a time of 2 to 5 hrs followed by rigorous washing, surface processing and drying steps to obtain dispersible, non-agglomerative, high tap density, narrow particle size distributed copper powders.

JP05235193B2 is directed to spherical copper powders of 0.05 to 0.25 microns synthesized through a disproportionation reaction by addition of copper bearing sub-oxide to an aqueous media comprising additives such as natural resin or polysaccharide to obtain a slurry followed by addition of 5 to 50% acid every 15 min.

CN109234767B is directed to spherical copper powders obtained by electrolysis of copper containing solution with addition of potassium ferrocyanide to yield a spherical copper powder having a particle size of 1 to 5 microns with a uniform particle size distribution. The spherical copper powder is collected on a stainless steel working electrode post treatment time of 1 to 4 hrs followed by extensive washing and drying steps.

CN111715885A is directed to a novel apparatus comprising atomizing cylinder, pipes, turntable, spray rings, high pressure water pan, liquid storage bin and cooling bin to synthesize spherical copper powders.

JP2006052442A discloses bulb or ball shaped copper powders that are synthesized using a novel apparatus, where the copper powder is melted and allowed to flow onto a rotating disk with controlled parameters and is collected centrifugally.

CN105861862B is directed to evenly distributed spherical copper alloy powder synthesized by adsorption of nano-dispersed powders of alumina, zirconia, tungsten carbide, etc onto the surface of copper powder followed by melting the nano-phase adsorbed copper at temperatures greater than 1100° C. and subsequent gas atomization.

U.S. Pat. No. 4,711,661A discloses spherical copper powders obtained by mechanical grinding of irregular copper powders to definite size fractions followed by plasma treatment at elevated temperatures of 5500-15000° C.

JP64004401A discloses synthesizing spheroidal copper powders by subjecting irregular copper powders obtained through water atomization routes to impingement against each other by use of fluid energy mill.

CN104874806A discloses using super fine copper oxide powder as a precursor for synthesizing spherical copper powder. The precursor is mixed with ceramic and/or carbon material and is subjected to heating in gaseous reducing atmosphere like hydrogen or ammonia or carbon monoxide. Obtained copper powder is subjected to heat treatment at temperatures above melting point of copper to enable melting, cooling and solidification of copper to form spherical copper.

CN104259469A discloses synthesis of spherical metal powders from irregular metal powder precursors by mixing the irregular precursors with carbon and/or ceramic material and subjecting the mixture to heat treatment at temperatures above melting point of copper to enable melting, cooling and solidification of copper to form spherical copper.

The aforementioned studies use multiple chemicals or include multiple steps for synthesis of spherical copper powder making the process more complex and tedious. A few processes which avoid using multiple chemicals employ irregular copper powders synthesized by conventional techniques as precursors; high temperatures of operation, i.e., beyond the melting point of copper; and energy intensive techniques to achieve spherical morphology making the processes more complex and costly.

Overall, there is an immense need for a simple yet scalable process for synthesizing pure spherical copper powders. The present disclosure attempts to address this need.

### SUMMARY OF THE INVENTION

The present disclosure provides a method for synthesizing spherical copper powder, comprising: a) mixing a copper oxide powder with a carbon source to obtain a mixture; b) heating the mixture at a temperature of 600-1070° C. for a period of more than 20 minutes in an inert atmosphere to obtain spherical copper powder; and c) separating the spherical copper powder from carbon to obtain pure spherical copper powder.

The present disclosure further provides a spherical copper powder, having a dense, spherical morphology; a mean particle size of less than 250 microns; and an oxygen content of less than 0.25% by weight.

### BRIEF DESCRIPTION OF THE DRAWINGS

FIG. 1 shows an exemplary process flow for synthesizing spherical copper powders according to the present disclosure.

FIG. 2 shows an X-ray diffraction graph of precursor copper oxide powder employed in Example 1.

FIG. 3 shows an X-ray diffraction graph of synthesized spherical copper powder obtained in Example 1.

FIG. 4 shows a Scanning Electron Micrograph of precursor copper oxide powder employed in Example 1.

FIG. 5 shows a Scanning Electron Micrograph of spherical copper powder obtained in Example 1.

FIG. 6 shows a Scanning Electron Micrograph of spherical copper powder obtained in Example 6.

FIG. 7 shows a cross section optical image of spherical copper powder obtained in Example 10.

### DESCRIPTION OF THE INVENTION

With respect to the use of any plural and/or singular terms herein, those having skill in the art can translate from the plural to the singular and/or from the singular to the plural as is appropriate to the context and/or application. The various singular/plural permutations may be expressly set forth herein for sake of clarity. The use of the expression “at least” or “at least one” suggests the use of one or more elements or ingredients or quantities, as the use may be in the embodiment of the disclosure to achieve one or more of the desired objects or results. Throughout this specification, the word “comprise”, or variations such as “comprises” or “comprising” or “containing” or “has” or “having” wherever used, will be understood to imply the inclusion of a stated element, integer or step, or group of elements, integers or steps, but not the exclusion of any other element, integer or step, or group of elements, integers or steps.

Reference throughout this specification to “some embodiments”, “one embodiment” or “an embodiment” means that a particular feature, structure or characteristic described in connection with the embodiment may be included in at least one embodiment of the present disclosure. Thus, the appearances of the phrases “in some embodiments”, “in one embodiment” or “in an embodiment” in various places throughout this specification may not necessarily all refer to the same embodiment. It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination.

The term “about” as used herein encompasses variations of +/−10% and more preferably +/−5%, as such variations are appropriate for practicing the present invention.

Several methods are disclosed in the art for synthesizing spherical copper powder from copper oxide. However, these methods employ multiple reagents, multiple process steps, and/or temperatures above the melting point of copper. The present disclosure provides a single step process where irregular copper oxide powder is reduced and spherodized simultaneously in an inert ambience to yield pure, dense, spherical and flowable copper powder at temperatures lower than the melting point of copper.

In some embodiments, the present disclosure provides a method for synthesizing spherical copper powder, said method comprising a) mixing a copper oxide powder with a carbon source to obtain a mixture; b) heating the mixture at a temperature of 600-1070° C. for a period of more than 20 minutes in an inert atmosphere to obtain spherical copper powder; and c) separating the spherical copper powder from carbon to obtain pure spherical copper powder.

The copper oxide powder employed as a precursor to prepare the spherical copper powder can be a powder comprising cupric oxide (CuO), cuprous oxide (Cu₂O), an intermediate copper oxide or a combination thereof. The term “intermediate copper oxide” as used herein refers to any intermediate oxide form of copper that may arise and exist in transformation between CuO and pure copper. In some embodiments, the precursor copper oxide powder is cupric oxide with a purity not less than 98%.

In some embodiments, the precursor copper oxide powder has a copper content of not less than 78% by weight. In some embodiments, the precursor copper oxide powder has a copper content of about 78-99%, 78-98%, 78-97%, 78-96%, 78-95%, 78-90%, 78-88%, 78-85%, 80-99%, 80-97%, 80-95%, 80-90%, 85-99%, 85-95% or 85-90%, including values and ranges thereof.

In some embodiments, the precursor copper oxide powder has a particle size of less than 75 microns. In some embodiments, the precursor copper oxide powder has a particle size of about 5-74, 5-70, 5-65, 5-60, 5-50, 5-45, 5-40, 5-35, 5-30, 5-25, 5-20, 5-15, 5-10, 10-74, 10-70, 10-65, 10-60, 10-50, 10-45, 10-40, 10-35, 10-30, 10-25, 10-20, 10-15, 20-74, 20-70, 20-65, 20-60, 20-50, 20-45, 20-40, 20-35, 20-30, 30-74, 30-70, 30-65, 30-60, 30-50, 30-45, 30-40, 40-70, 40-60, 40-50, 50-70, or 55-75 microns, including values and ranges thereof.

The precursor copper oxide powder can have any combination of the copper content and the particle sizes disclosed herein.

The precursor copper oxide powder is mixed with a carbon source to reduce copper oxide to copper. In some embodiments, the carbon source is graphite, coal, graphene, coke, activated carbon or a combination thereof. In some embodiments, coal is anthracite coal. In some embodiments, coke is coke breeze, coke dry quenching (CDQ) dust, nut coke or a combination thereof.

In some embodiments, the carbon source has a particle size of less than 75 microns such as a particle size of about 5-74, 5-70, 5-65, 5-60, 5-50, 5-45, 5-40, 5-35, 5-30, 5-25, 5-20, 5-15, 5-10, 10-74, 10-70, 10-65, 10-60, 10-50, 10-45, 10-40, 10-35, 10-30, 10-25, 10-20, 10-15, 20-74, 20-70, 20-65, 20-60, 20-50, 20-45, 20-40, 20-35, 20-30, 30-74, 30-70, 30-65, 30-60, 30-50, 30-45, 30-40, 40-70, 40-60, 40-50, 50-70, or 55-75 microns, including values and ranges thereof.

The carbon source is mixed with the precursor copper oxide powder to obtain a mixture, where the carbon source constitutes at least about 7% by weight of the mixture. In some embodiments, the carbon source constitutes about 7-40%, 7-35%, 7-30%, 7-25%, 7-20%, 7-15%, 7-10%, 10-40%, 10-35%, 10-30%, 10-25%, 10-20%, 10-15%, 15-40%, 15-35%, 15-30%, 15-25%, 15-20%, 20-40%, 20-35%, 20-30%, 20-25%, 25-40%, 25-35%, 25-30%, 30-40%, 30-35%, or 35-40%, including values and ranges thereof, by weight of the mixture. In some embodiments, the carbon source constitutes about 7-30% by weight of the mixture.

In some embodiments, an inert ceramic powder is added as a spherodization aid to the mixture containing the precursor copper oxide powder and the carbon source. In exemplary embodiments, the inert ceramic powder comprises silica, alumina, other inert materials, or combinations thereof, that acts as a bed for precursor copper oxide particles. Ceramic powder is added in an amount of 0% (no addition of ceramic powder) to about 15% by weight of the mixture containing the precursor copper oxide powder, the carbon source, and the ceramic powder. In some embodiments, the ceramic powder constitutes about 0.1-15%, 0.1-13%, 0.1-11%, 0.1-10%, 0.1-9%, 0.1-7%, 0.1-5%, 1-15%, 1-13%, 1-11%, 1-10%, 1-9%, 1-7%, 1-5%, 2.5-15%, 2.5-13%, 2.5-11%, 2.5-10%, 2.5-9%, 2.5-7%, 2.5-5%, 5-15%, 5-13%, 5-11%, 5-10%, 5-9%, 5-7%, 7.5-15%, 7.5-13%, 7.5-11%, 7.5-10%, 7.5-9%, 9-15%, 9-13%, 9-11%, 10-15%, or 10-13%, including values and ranges thereof, by weight of the mixture.

In some embodiments, the ceramic powder has a particle size of less than 75 microns such as a particle size of about 5-74, 5-70, 5-65, 5-60, 5-50, 5-45, 5-40, 5-35, 5-30, 5-25, 5-20, 5-15, 5-10, 10-74, 10-70, 10-65, 10-60, 10-50, 10-45, 10-40, 10-35, 10-30, 10-25, 10-20, 10-15, 20-74, 20-70, 20-65, 20-60, 20-50, 20-45, 20-40, 20-35, 20-30, 30-74, 30-70, 30-65, 30-60, 30-50, 30-45, 30-40, 40-70, 40-60, 40-50, 50-70, or 55-75 microns, including values and ranges thereof.

In some embodiments, the mixing of precursor copper oxide powder, carbon source and optionally inert ceramic powder is facilitated by simple mechanical mixing units comprising electricity-driven mechanical parts with or without media to facilitate uniform and homogenous mixing of ingredients. Mixing units include, but are not limited to, turbo mixer, kneader, cone blender, etc.

The mixture containing the precursor copper oxide powder and the carbon source, and optionally the inert ceramic powder, is heated at a temperature below the melting point of copper. The melting point of copper is 1085° C. In some embodiments, the mixture is heated at a temperature of about 600-1070° C., 600-1060° C., 600-1050° C., 600-1030° C., 600-1000° C., 600-950° C., 600-900° C., 600-850° C., 650-1070° C., 650-1060° C., 650-1050° C., 650-1030° C., 650-1000° C., 650-950° C., 650-900° C., 650-850° C., 700-1070° C., 700-1060° C., 700-1050° C., 700-1030° C., 700-1000° C., 700-950° C., 700-900° C., 700-850° C., 750-1070° C., 750-1060° C., 750-1050° C., 750-1030° C., 750-1000° C., 750-950° C., 750-900° C., 750-850° C., 800-1070° C., 800-1060° C., 800-1050° C., 800-1030° C., 800-1000° C., 800-950° C., 800-900° C., 850-1070° C., 850-1060° C., 850-1050° C., 850-1030° C., 850-1000° C., 850-950° C., 900-1070° C., 900-1060° C., 900-1050° C., 900-1030° C., 900-1000° C., or 1000-1070° C. In some embodiments, the mixture is heated at a temperature of about 600° C., 650° C., 700° C., 750° C., 800° C., 850° C., 900° C., 950° C., 1000° C., 1010° C., 1020° C., 1030° C., 1040° C., 1050° C., 1060° C., or 1070° C.

In some embodiments, the mixture is heated at any of the temperatures disclosed above for a period of about 20 minutes to 300 minutes, such as about 20-250, 20-240, 20-220, 20-200, 20-180, 20-150, 20-120, 20-100, 20-80, 20-60, 30-250, 30-240, 30-220, 30-200, 30-180, 30-150, 30-120, 30-100, 30-80, 30-60, 40-250, 40-240, 40-220, 40-200, 40-180, 40-150, 40-120, 40-100, 40-80, 40-60, 60-250, 60-240, 60-220, 60-200, 60-180, 60-150, 60-120, 60-100, 60-80, 90-250, 90-240, 90-220, 90-200, 90-180, 90-150, 90-120, 120-250, 120-240, 120-220, 120-200, 120-180, 120-150, 150-250, 150-220, 150-200, 180-250, 180-220, 200-250, or 220-250 minutes, including values and ranges thereof.

The mixture containing the precursor copper oxide powder and the carbon source, and optionally the inert ceramic powder, is heated at any of the temperature and time conditions disclosed herein in an inert atmosphere. In some embodiments, the inert atmosphere is provided by nitrogen, argon, helium, vacuum, or a combination thereof.

The step of heating can be carried out in a conventional electricity-based heating furnace or its equivalent. In some embodiments, the step of heating is carried out in a muffle type, pusher type, tubular type, belt type controlled atmosphere furnace or a combination thereof.

Heating the precursor copper oxide powder with the carbon source in the manner disclosed herein reduces copper oxide to provide spherical copper powder. The spherical copper powder formed in the bed of the carbon source is separated from carbon to obtain pure spherical copper powder. In some embodiments, the spherical copper powder is separated from carbon by washing, cleaning, centrifugation, advanced separation techniques, like centrifugation, ultra-centrifugation, etc, or a combination thereof.

In some embodiments, the spherical copper powder is separated from carbon by washing the spherical copper powder using a solvent selected from acetone, toluene, isopropyl alcohol, water, or a combination thereof. Washing of spherical copper powder can be a static type, floating type, or any other motion-oriented washing. In some embodiments, the mode of washing may include usage of special energy like turbulence, ultrasonication, or other equivalents.

In some embodiments, sieving may be performed to remove agglomerates, if any, before washing or cleaning the spherical copper powder.

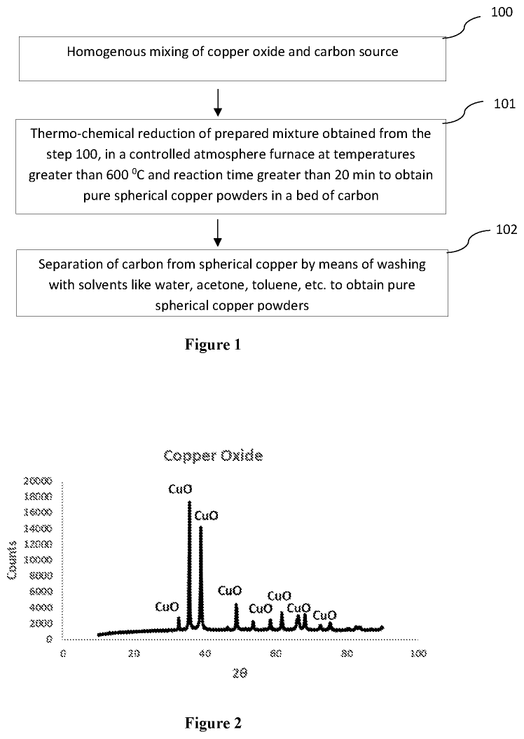

An exemplary process flow for synthesizing spherical copper powder according to the present disclosure is shown in FIG. 1. At step 100 (FIG. 1), the precursor materials such as copper oxide, carbon source such as graphite are homogenously mixed, for example, using a turbo mixer or equivalent to obtain a raw material mix. At step 101 (FIG. 1), the obtained raw material mix is subjected to thermo-chemical reduction in an elongated muffle type-controlled atmosphere furnace, comprising pre-heating zone and hot and cold zone in the same length of operation. Once the furnace reaches the target temperature of operation, the raw mix enters the furnace through small non-reactive metal or ceramic boats from the entry side. The boats quickly pass the pre-heating zone and are held for a targeted reaction time of operation in the hot zone of the furnace. Once the reaction time is complete, the boats are allowed to reach the room temperature in the cooling zone of the furnace before they are taken out. At step 102 (FIG. 1), the obtained product comprising spherical copper powders in the bed of carbon is subjected to washing, for example, using solvents such as water, acetone, iso-propyl alcohol, toluene, or other equivalents to separate copper from carbon or wash away carbon to retain copper.

The methods of the present disclosure provide dense, spherical copper powder having one or more of the following characteristics:
a. an oxygen content of less than 0.25% by weight;
b. a purity of 98.5% or more;
c. a mean particle size of less than 250 microns;
d. a true density greater than 8.6 g/cc;
e. an apparent density greater than 4 g/cc;
f. a tap density greater than 4.5 g/cc; and
g. a flowability less than 25 s/50 g.

In some embodiments, the spherical copper powder has an oxygen content of less than 0.25% by weight, such as about 0.01-0.2%, 0.01-0.15%, 0.01-0.1%, 0.01-0.08%, 0.01-0.05%, 0.05-0.2%, 0.05-0.15%, 0.05-0.1%, 0.05-0.08%, 0.1-0.2%, or 0.1-0.15%, including values and ranges thereof. In some embodiments, the spherical copper powder has an oxygen content of less than 0.1% by weight, such as about 0.01-0.09%, 0.01-0.08%, 0.01-0.07%, 0.01-0.06%, or 0.01-0.05% by weight, including values and ranges thereof. In some embodiments, the spherical copper powder has an oxygen content of about 0.4-0.8% by weight, such as, about 0.4-0.7, 0.5-0.7, or 0.6-0.7% by weight, including values and ranges therebetween.

In some embodiments, the spherical copper powder provided by the methods of the present disclosure has a purity of 98.5% or more, such as, about 98.5-99.9%, 98.5-99.5%, 98.5-99%, 98.6%, 98.7%, 98.8%, 98.9%, 99%, 99.1%, 99.2%, 99.3%, 99.4%, 99.5%, 99.6%, 99.7%, 99.8%, or 99.9%, including values and ranges thereof. In some embodiments, the spherical copper powder has a purity of 99% or more.

In some embodiments, the spherical copper powder has a mean particle size of less than 250 microns, such as about 1-245, 1-230, 1-220, 1-200, 1-180, 1-150, 1-125, 1-100, 1-80, 1-50, 1-25, 5-245, 5-230, 5-225, 5-200, 5-180, 5-150, 5-125, 5-100, 5-75, 5-50, 10-240, 10-225, 10-200, 10-175, 10-150, 10-125, 10-100, 10-75, 10-50, 25-245, 25-225, 25-200, 25-175, 25-150, 25-125, 25-100, 25-75, 25-50, 50-245, 50-225, 50-200, 50-175, 50-150, 50-125, 50-100, 75-245, 75-225, 75-200, 75-175, 75-150, 75-125, 100-245, 100-225, 100-200, 100-150, 125-245, 125-225, 125-200, 125-175, 150-245, 150-225, 150-200, 175-245, 175-225, or 200-245 microns, including values and ranges thereof. In some embodiments, the spherical copper powder has a mean particle size of less than 150 microns. In some embodiments, the spherical copper powder has a mean particle size of less than 100 microns.

In some embodiments, the spherical copper powder has a true density of greater than 8.6 g/cc, such as about, 8.6-9.8, 8.6-9.5, 8.6-9.3, or 8.6-8.9 g/cc, including values and ranges thereof. In some embodiments, the spherical copper powder has a true density of greater than 8.7 g/cc.

In some embodiments, the spherical copper powder has an apparent density of greater than 4 g/cc, such as about 4-5.5, 4-5.3, 4-5.1, 4-5, 4-4.9, or 4-4.7 g/cc, including values and ranges thereof. In some embodiments, the spherical copper powder has an apparent density of greater than 4.5 g/cc.

In some embodiments, the spherical copper powder has a tap density of greater than 4.5 g/cc, such as, about 4.5-6, 4.5-5.8, 4.5-5.5, 4.8-6, 4.8-5.8, or 5-6 g/cc, including values and ranges thereof. In some embodiments, the spherical copper powder has a tap density of greater than 5 g/cc.

In some embodiments, the spherical copper powder has a flowability of less than 25 s/50 g, such as about 15-24 s/50 g, 15-22 s/50 g, 15-20 s/50 g, 15-18 s/50 g, 17-24 s/50 g, 17-22 s/50 g, 17-20 s/50 g, 18-24 s/50 g, or 18-22 s/50 g, including values and ranges thereof. In some embodiments, the spherical copper powder has a flowability of less than 20 s/50 g.

The spherical copper powders of the present disclosure have a dense, spherical morphology with any combination of the oxygen content, purity, mean particle size, true density, apparent density, tap density, and flowability disclosed herein.

It is to be understood that the foregoing descriptive matter is illustrative of the disclosure and not a limitation. While considerable emphasis has been placed herein on the particular features of this disclosure, it will be appreciated that various modifications can be made, and that many changes can be made in the preferred embodiments without departing from the principles of the disclosure. Those skilled in the art will recognize that the embodiments herein can be practiced with modification within the spirit and scope of the embodiments as described herein. Similarly, additional embodiments and features of the present disclosure will be apparent to one of ordinary skill in art based upon description provided herein.

Descriptions of well-known/conventional methods/steps and techniques are omitted so as to not unnecessarily obscure the embodiments herein. Further, the disclosure herein provides for examples illustrating the above-described embodiments, and in order to illustrate the embodiments of the present disclosure certain aspects have been employed. The examples used herein for such illustration are intended merely to facilitate an understanding of ways in which the embodiments herein may be practiced and to further enable those of skill in the art to practice the embodiments herein. Accordingly, the following examples should not be construed as limiting the scope of the embodiments herein.

### Examples

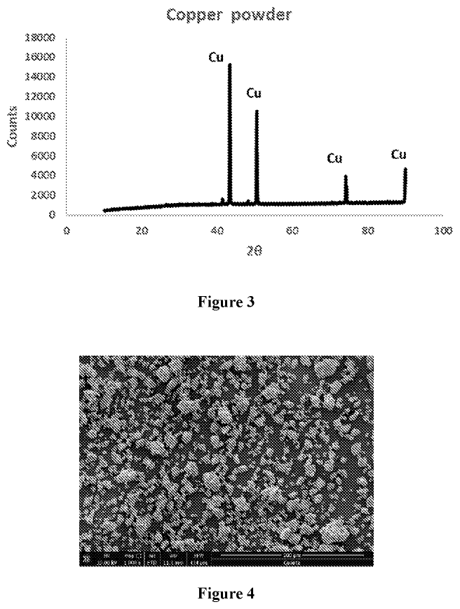

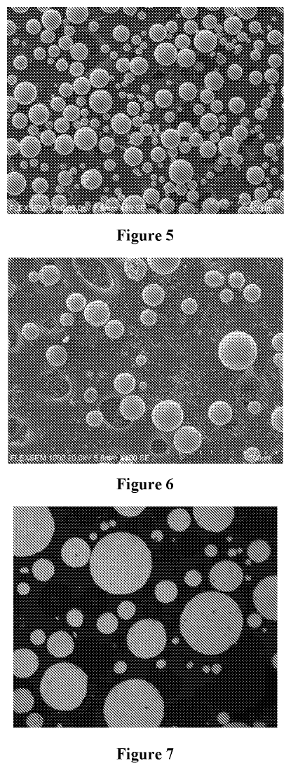

Example 1: In this example, 89 grams of copper oxide, having a copper content of at least 78 wt % and a mean particle size less than 75 microns as shown in FIG. 4 is mixed with 11 grams of graphite powder comprising a fixed carbon percentage of at least 98% and a mean particle size less than 75 microns in a turbo mixer to get 100 grams of raw mix bearing 11 wt % graphite. The obtained raw mix was collected in an Inconel sample boat and subjected to thermo chemical treatment in a pusher type furnace. The furnace was heated to an operating temperature of 1050° C. and the raw mix was introduced into the furnace through the pre-heating zone under nitrogen atmosphere. The sample was allowed to react in a static bed form for a reaction time of 60 minutes in the nitrogen ambience and then pushed to cooling zone of the furnace. The copper oxide powder undergoes chemical reduction in the presence of solid graphite powder and the newly-formed copper from the reduction of copper oxide simultaneously undergoes superficial melting, and due to surface tension forces of slightly molten copper in combination with interfacial forces of porous bed of carbon acting upon the formed copper particles results in spherodization of copper particles in the bed of carbon and the spherical morphology of the particles is retained due to solidification post cooling to room temperatures. Here the carbon bed acts as both a reducing agent as well as a spherodization aid. Cooled sample was taken out of cooling zone and was subjected to thorough washing with acetone to collect pure, spherical copper out of carbon. The carbon washed out was collected in filter media and acetone was collected for re-use. Pure and dense copper powders of spherical morphology as shown in FIG. 5 having a purity 99.10% of copper, 0.092% oxygen and less than 0.2% impurities and a mean particle size of about 111.2 microns were obtained. XRD micrograph of the raw material copper oxide and obtained pure spherical copper powder are shown in FIG. 2 and FIG. 3, respectively. Copper powders of dense morphology and particle sizes varying from 5 microns to 180 microns are formed.

Example 2: In this example, a raw mix with 11 wt % of graphite in copper oxide was prepared and subjected to the thermo-chemical reduction as mentioned in Example 1 at an operating temperature of 1050° C. and a reaction time of 30 minutes. Pure and dense copper powders of spherical morphology having a purity 98.81% of copper, 0.124% oxygen and less than 0.2% impurities and mean particle size of about 101.1 microns were obtained.

Example 3: In this example, raw mix with 11 wt % of graphite in copper oxide was prepared and subjected to the thermo-chemical reduction as mentioned in Example 1 with an operating temperature of 950° C. and a reaction time of 30 minutes. Pure and dense copper powders of spherical morphology having purity 98.7% of copper, 0.13% oxygen and less than 0.2% impurities and mean particle size of about 107.3 microns were obtained.

Example 4: In this example, raw mix with 11 wt % of graphite in copper oxide was prepared and subjected to the thermo-chemical reduction as mentioned in Example 1 with an operating temperature of 950° C. and a reaction time of 60 minutes. Pure and dense copper powders of spherical morphology having a purity 99.02% of copper, 0.1% oxygen and less than 0.2% impurities and mean particle size of about 110.7 microns were obtained.

Example 5: In this example, raw mix with 11 wt % of graphite in copper oxide was prepared and subjected to the thermo-chemical reduction as mentioned in Example 1 with an operating temperature of 950° C. and a reaction time of 240 minutes. Pure and dense copper powders of spherical morphology having purity 99.16% of copper, 0.07% oxygen and less than 0.2% impurities and mean particle size of about 104.6 microns were obtained. Apart from the main copper powder collected, very fine copper powders with spherical morphology and mean particle size about 5 microns was collected in the washed filtered product along with carbon.

Example 6: In this example, raw mix with 11 wt % of graphite in copper oxide was prepared and subjected to the thermo-chemical reduction as mentioned in Example 1 with an operating temperature of 850° C. and a reaction time of 240 minutes. Pure and dense copper powders of spherical morphology as shown in the FIG. 6 having a purity 98.63% of copper, 0.17% oxygen and less than 0.2% impurities and mean particle size of about 106.3 microns were obtained.

Example 7: In this example, raw mix with 11 wt % of graphite in copper oxide was prepared and subjected to the thermo-chemical reduction as mentioned in Example 1 with an operating temperature of 850° C. and a reaction time of 120 minutes. Pure and dense copper powders of spherical morphology having a purity 99.5% of copper, 0.16% oxygen and less than 0.2% impurities and mean particle size of about 111.8 microns were obtained.

Example 8: In this example, raw mix with 11 wt % of graphite in copper oxide was prepared and subjected to the thermo-chemical reduction as mentioned in Example 1 with an operating temperature of 750° C. and a reaction time of 120 minutes. Pure and dense copper powders of spherical morphology having a purity 98.52% of copper, 0.22% oxygen and less than 0.2% impurities and mean particle size of about 90.9 microns were obtained.

Example 9: In this example, raw mix with 11 wt % of graphite in copper oxide was prepared and subjected to the thermo-chemical reduction as mentioned in Example 1 with an operating temperature of 650° C. and a reaction time of 120 minutes. Pure and dense copper powders of spherical morphology having purity 98.68% of copper, greater than 0.2% oxygen and less than 0.2% impurities and a mean particle size of about 97.1 microns were obtained wherein the yield of spherical copper was less and a few number of irregular copper particles were also observed.

Example 10: In this example, raw mix with 10.5 wt % of graphite in copper oxide was prepared and subjected to the thermo-chemical reduction as mentioned in Example 1 with an operating temperature of 1050° C. and a reaction time of 240 minutes. Pure and dense copper powders of spherical morphology having purity 99.05% of copper, 0.06% oxygen and less than 0.2% impurities and mean particle of about 93.8 microns were obtained. Dense morphology of copper powder formed was clearly visible in the cross sectional image analysis shown in FIG. 7.

Example 11: In this example, raw mix with 14 wt % of graphite in copper oxide was prepared and subjected to the thermo-chemical reduction as mentioned in Example 1 with an operating temperature of 1050° C. and a reaction time of 240 minutes. Pure and dense copper powders of spherical morphology having purity 99.34% of copper, 0.05% oxygen and less than 0.2% impurities and mean particle size of about 101.6 microns were obtained.

Example 12: In this example, raw mix with 20 wt % of graphite in copper oxide was prepared and subjected to the thermo-chemical reduction as mentioned in Example 1 with an operating temperature of 1000° C. and a reaction time of 240 minutes. Pure and dense copper powders of spherical morphology having purity 98.84% of copper, 0.12% oxygen and less than 0.2% impurities and mean particle size of about 100.3 microns were obtained.

Example 13: In this example, raw mix with 15 wt % of graphite in copper oxide was prepared and subjected to the thermo-chemical reduction as mentioned in Example 1 with an operating temperature of 1000° C. and a reaction time of 240 minutes. Pure and dense copper powders of spherical morphology having purity 99.02% of copper, 0.07% oxygen and less than 0.2% impurities and mean particle size of about 112.3 microns were obtained.

In the next set of examples, carbon sources used in the steel industry were used as a carbon source and the steps mentioned in Example 1 were performed.

Example 14: In this example, a raw mix with 30% wt of coke breeze fines having a fixed carbon of about 75% wt in a copper oxide was prepared and subjected to the thermo-chemical reduction as mentioned in Example 1 with an operating temperature of 1050° C. and a reaction time of 240 minutes. Pure and dense copper powders of spherical morphology having purity 98.53% of copper, 0.638% oxygen and mean particle size of about 89.5 microns were obtained.

Example 15: In this example, a raw mix with 30% wt of coke dry quench fines having a fixed carbon of about 75% wt, in copper oxide was prepared and subjected to the thermo-chemical reduction as mentioned in Example 1 with an operating temperature of 1050° C. and a reaction time of 240 minutes. Pure and dense copper powders of spherical morphology having purity 98.45% of copper, 0.641% oxygen and a mean particle size of about 93.9 microns were obtained.

Example 16: In this example, a raw mix with 30% wt of anthracite coal fines having fixed carbon of about 84% wt, in copper oxide was prepared and subjected to the thermo-chemical reduction as mentioned in Example 1 with an operating temperature of 1050° C. and a reaction time of 240 minutes. Pure and dense copper powders of spherical morphology having purity 98.54% of copper, 0.672% oxygen and mean particle size of about 107.5 microns were obtained.

Example 17: In this example, a raw mix with 15% wt of nut coke fines having fixed carbon of about 82% wt, in copper oxide was prepared and subjected to the thermo-chemical reduction as mentioned in Example 1 with an operating temperature of 1050° C. and a reaction time of 240 minutes. Pure and dense copper powders of spherical morphology having purity 98.51% of copper, 0.7% oxygen and mean particle size of about 110.8 microns were obtained.

Example 18: In this example, a raw mix with 15% wt of spent activated carbon fines having a fixed carbon of about 78% wt, in copper oxide was prepared and subjected to the thermo-chemical reduction as mentioned in Example 1 with an operating temperature of 1050° C. and a reaction time of 240 minutes. Pure and dense copper powders of spherical morphology having purity 99.14% of copper, 0.413% oxygen and mean particle size of about 96 microns were obtained.

Experimental parameters employed in Examples 1-16 and characteristics of copper powders obtained are shown in Table 1 and Table 2, respectively.

TABLE 1
Experimental parameters

| | | Weight % of | Operating | Operating |
|---|---|---|---|---|
| Example | Carbon | carbon source | temperature | time |
| Number | source | in the mixture | (° C.) | (min) |
| Example 1 | Graphite | 11 | 1050 | 60 |
| Example 2 | Graphite | 11 | 1050 | 30 |
| Example 3 | Graphite | 11 | 950 | 30 |
| Example 4 | Graphite | 11 | 950 | 60 |
| Example 5 | Graphite | 11 | 950 | 240 |
| Example 6 | Graphite | 11 | 850 | 240 |
| Example 7 | Graphite | 11 | 850 | 120 |
| Example 8 | Graphite | 11 | 750 | 120 |
| Example 9 | Graphite | 11 | 650 | 120 |
| Example 10 | Graphite | 10.5 | 1050 | 240 |
| Example 11 | Graphite | 14 | 1050 | 240 |
| Example 12 | Graphite | 20 | 1000 | 240 |
| Example 13 | Graphite | 15 | 1000 | 240 |
| Example 14 | Coke breeze | 30 | 1050 | 240 |
| Example 15 | Coke dry | 30 | 1050 | 240 |
| | quenching | | | |
| | fines | | | |
| Example 16 | Anthracite | 30 | 1050 | 240 |
| | coal | | | |
| Example 17 | Nut coke | 15 | 1050 | 240 |
| | fines | | | |
| Example 18 | Spent | 15 | 1050 | 240 |
| | activated | | | |
| | carbon | | | |
| | fines | | | |

TABLE 2
Chemical composition and mean particle
size of synthesized copper powders

| Example | Copper | Oxygen | Mean Particle |
|---|---|---|---|
| Number | (wt %) | (wt %) | size (microns) |
| Example 1 | 99.10 | 0.092 | 111.2 |
| Example 2 | 98.81 | 0.124 | 101.1 |
| Example 3 | 98.7 | 0.13 | 107.3 |
| Example 4 | 99.02 | 0.1 | 110.7 |
| Example 5 | 99.16 | 0.07 | 104.6 |
| Example 6 | 98.63 | 0.17 | 106.3 |
| Example 7 | 99.5 | 0.16 | 111.8 |
| Example 8 | 98.52 | 0.22 | 90.9 |
| Example 9 | 98.68 | 0.287 | 97.1 |
| Example 10 | 99.05 | 0.06 | 93.8 |
| Example 11 | 99.34 | 0.05 | 101.6 |
| Example 12 | 98.84 | 0.12 | 100.3 |
| Example 13 | 99.02 | 0.07 | 112.3 |
| Example 14 | 98.53 | 0.638 | 89.5 |
| Example 15 | 98.45 | 0.641 | 93.9 |
| Example 16 | 98.54 | 0.672 | 107.5 |
| Example 17 | 98.51 | 0.7 | 110.8 |
| Example 18 | 99.14 | 0.413 | 96 |

Spherical copper powders collected from Examples 1, 2, 3, 4, 5, 10, 11, 12, and 13 are sieved from 80 mesh or 180 microns sieve and evaluated to determine the density and flowability characteristics. True density is measured using gas pycnometers, apparent density and tap density are measured using PT-X powder tester and flowability is measured using halls flow meter. Obtained values of density and flow parameters are shown in a Table 3.

TABLE 3
Density and flowability measurements of synthesized
spherical copper powders

| | True | Apparent | Tap | |
|---|---|---|---|---|
| Example | density | density | density | Flowability |
| Number | (g/cc) | (g/cc) | (g/cc) | (s/50 g) |
| Example 1 | 8.71 | 4.97 | 5.36 | 18.6 |
| Example 2 | 8.72 | 4.86 | 5.3 | 19.6 |
| Example 3 | 8.67 | 4.34 | 4.91 | 20.9 |
| Example 4 | 8.69 | 4.63 | 5.01 | 19.47 |
| Example 5 | 8.71 | 4.23 | 4.79 | 23.2 |
| Example 10 | 8.75 | 4.78 | 5.71 | 18.07 |
| Example 11 | 8.8 | 4.76 | 5.26 | 17.16 |
| Example 12 | 8.7 | 4.73 | 5.4 | 18.26 |
| Example 13 | 8.72 | 4.75 | 5.3 | 18.02 |

1. A method for synthesizing spherical copper powder, comprising:
a. mixing a copper oxide powder with a carbon source to obtain a mixture;
b. heating the mixture at a temperature of 600-1070° C. for a period of more than 20 minutes in an inert atmosphere to obtain spherical copper powder; and
c. separating the spherical copper powder from carbon to obtain pure spherical copper powder.

2. The method as claimed in claim 1, wherein said copper oxide powder is a powder comprising cupric oxide, cuprous oxide, an intermediate copper oxide or a combination thereof.

3. The method as claimed in claim 1, wherein said copper oxide powder has a copper content not less than 78% by weight.

4. The method as claimed in claim 1, wherein said copper oxide powder has a particle size that is less than 75 microns.

5. The method as claimed in claim 1, wherein the carbon source is selected from the group consisting of graphite, coal, graphene, coke, activated carbon and a combination thereof.

6. The method as claimed in claim 5, wherein said coal is anthracite coal.

7. The method as claimed in claim 5, wherein said coke is coke breeze, coke dry quenching (CDQ) dust, nut coke or a combination thereof.

8. The method as claimed in claim 1, wherein the carbon source has a particle size that is less than 75 microns;
or wherein the carbon source constitutes at least about 7% by weight of the mixture.

9. (canceled)

10. The method as claimed in claim 1, wherein an inert ceramic powder is optionally added to the mixture as a spherodization aid.

11. The method as claimed in claim 1, wherein the mixture is heated at a temperature of about 600-1070° C. for a period of about 20 minutes to 300 minutes.

12. The method as claimed in claim 1, wherein the inert atmosphere is provided by nitrogen, argon, helium, vacuum, or a combination thereof.

13. The method as claimed in claim 1, wherein said separating the spherical copper powder from carbon comprises washing, cleaning, centrifugation, or a combination thereof.

14. The method as claimed in claim 13, wherein said washing comprises washing the spherical copper powder by a solvent selected from acetone, toluene, isopropyl alcohol, water, or a combination thereof.

15. The method as claimed in claim 1, wherein the method is performed at a temperature below melting point of copper.

16. The method as claimed in claim 1, wherein the spherical copper powder has a dense morphology, with an oxygen content of less than 0.25% by weight; and the spherical copper powder has a purity of 98.5% or mom.

17. (canceled)

18. The method as claimed in claim 1, wherein the spherical copper powder has one or more of the following properties:
a mean particle size of less than 250 microns,
a true density greater than 8.6 g/cc;
an apparent density greater than 4 g/cc;
a tap density greater than 4.5 g/cc; and
flowability less than 25 s/50 g.

19-22. (canceled)

23. A spherical copper powder obtained by the method as claimed in claim 1.

24. A spherical copper powder, having a dense morphology; a mean particle size of less than 250 microns; and an oxygen content of less than 0.25% by weight, preferably less than 0.1% by weight.

25. The spherical copper powder as claimed in claim 24, having one or more of the following properties:
a true density greater than 8.6 g/cc;
an apparent density greater than 4 g/cc;
a tap density greater than 4.5 g/cc; and
a flowability less than 25 s/50 g.

26. The spherical copper powder as claimed in claim 24, wherein the spherical copper powder is obtained from a powder comprising cupric oxide, cuprous oxide, an intermediate copper oxide or a combination thereof.
